(19) United States
(12) Patent Application Publication
(10) Pub. No.: US 2026/0191382 A1
(43) Pub. Date: Jul. 9, 2026

(54) Cleaning Device

(71) Applicant: Uproot Lint LLC, Doral, FL (US)

(72) Inventors: Mehul Patel, Doral, FL (US); Jian Feng Zhang, New York, NY (US)

(73) Assignee: Uproot Lint LLC, Doral, FL (US)

(21) Appl. No.: 19/480,095

(22) PCT Filed: Aug. 13, 2025
(86) PCT No.: PCT/US2025/041854

§ 371 Date: Oct. 30, 2025

Related U.S. Application Data
(60) Provisional application No. 63/682,980, filed on Aug. 14, 2024.

(51) Int. Cl. A47L 9/06; A01K 13/00; A47L 7/00

(52) U.S. Cl. CPC A47L 9/0653; A01K 13/0021; A47L 7/0066

(57) ABSTRACT

A cleaning device includes a housing assembly and a teeth assembly. The housing assembly includes an upper section and a lower section configured to receive the teeth assembly therebetween. The lower section includes an outer edge. The teeth assembly includes an outer section and an inner section, which are movable in opposite directions of each other. The outer section includes a teeth member extending from the housing assembly and abutting the outer edge. In a rested state, the teeth member is biased away from the housing assembly and extends substantially beyond the outer edge. In an engaged state, the teeth member is retracted and is positioned substantially inward of the outer edge while debris is removed from the teeth member by the outer edge.

### CROSS-REFERENCE TO RELATED APPLICATION

The present application claims priority to U.S. Provisional Application No. 63/682,980, titled “Cleaning Device,” filed on Aug. 14, 2024, which is incorporated by reference.

### FIELD OF INVENTION

The present invention relates to cleaning devices in general, and in particular to a device with a teeth member for improved cleaning.

### BACKGROUND

Many types of cleaning devices exist for different purposes. Some examples include: brooms, which are normally used to sweep hard surfaces; mops, which are used to wipe down hard surfaces; vacuum cleaners, which are used to clean different types of surfaces by using suction; and lint lifters, which are used to remove lint and hair from surfaces using an adhesive.

While each of the above-mentioned cleaning devices may generally serve its intended purpose, it is difficult to find a cleaning device that is able to remove small fibrous debris such as pet hair, human hair and lint lodged within a fibrous surface. For example, surfaces of clothing, carpet, furniture, car seats, car mats and door mats include a depth in which such light fibrous debris could be entangled and lodged. Such fibrous debris is hard to remove even with a vacuum cleaner because the debris is lodged deep into the surface and within the fibers of the surface. Prior art vacuum cleaners and vacuum cleaner attachments for cleaning fibrous surfaces only include bristles to aid in dislodging debris from the surface but are ineffective.

Also, pets that shed hair, such as cats and dogs, tend to shed hair in the house, which requires the homeowner to constantly clean pet hair that is shed. While hairbrushes are available to collect hair directly from the pet, this requires cleaning of the brush after use and cleaning dislodged hair from the pet's surroundings, which is messy and time consuming.

Thus, a need exists for a simple and affordable cleaning device that can efficiently remove and dispose of light fibrous debris from fibrous surfaces, and also act as a grooming device for pets, as a stand-alone device or an attachment for vacuum cleaners.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention provides a simple and affordable cleaning device that can efficiently remove light debris from fibrous surfaces, and directly from pets with hair.

In one aspect, the present invention provides a cleaning device comprising a housing assembly and a teeth assembly, the housing assembly comprising an upper section and a lower section, the housing assembly configured to receive the teeth assembly between the upper and lower sections, the lower section of the housing assembly comprising an outer edge; the teeth assembly comprising an outer section and an inner section, the outer section and inner section movable in opposite directions of each other longitudinally, the outer section comprising a teeth member extending from the housing assembly and abutting the housing assembly outer edge, wherein the teeth assembly outer section comprises an inner rack and the teeth assembly inner section comprises an outer rack, the inner and outer racks coupled to a rotatable pinion such that the teeth assembly inner and outer sections are movable relative to each other, and wherein the teeth assembly inner section further comprises an engagement shaft extending therefrom, such that when a force is applied to the engagement shaft, the teeth member is retracted; wherein in a rested state, the teeth member of the teeth assembly is biased away from the housing assembly and extends substantially beyond the outer edge of the housing assembly lower section, and in an engaged state, the teeth member of the teeth assembly is retracted and is positioned substantially inward of the outer edge of the housing assembly lower section.

In another aspect, the present invention provides a cleaning device comprising a housing assembly and a teeth assembly, the housing assembly comprising an upper section and a lower section, the housing assembly configured to receive the teeth assembly between the upper and lower sections, the lower section of the housing assembly comprising an outer edge; the teeth assembly comprising an outer section and an inner section, the outer section and inner section movable in opposite directions of each other longitudinally, the outer section comprising a teeth member extending from the housing assembly and abutting the housing assembly outer edge, wherein the teeth assembly outer section comprises an inner rack and the teeth assembly inner section comprises an outer rack, the inner and outer racks coupled to a rotatable pinion such that the teeth assembly inner and outer sections are movable relative to each other, and wherein the teeth assembly inner section further comprises an engagement shaft extending therefrom, such that when a force is applied to the engagement shaft, the teeth member is retracted; wherein in a rested state, the teeth member of the teeth assembly is biased away from the housing assembly and extends substantially beyond the outer edge of the housing assembly lower section, and in an engaged state, the teeth member of the teeth assembly is retracted and is positioned substantially inward of the outer edge of the housing assembly lower section.

In yet another aspect, the present invention provides a cleaning device comprising a housing assembly and a teeth assembly, the housing assembly comprising an upper section and a lower section, the housing assembly configured to receive the teeth assembly, the lower section of the housing assembly comprising an outer edge; the teeth assembly comprising an outer section and an inner section, the outer section and inner section movable in opposite directions of each other longitudinally, the outer section comprising a teeth member extending from the housing assembly and abutting the housing assembly outer edge; wherein in a rested state, the teeth member of the teeth assembly is biased away from the housing assembly and extends substantially beyond the outer edge of the housing assembly lower section, and in an engaged state, the teeth member of the teeth assembly is retracted and is positioned substantially inward of the outer edge of the housing assembly lower section.

### BRIEF DESCRIPTION OF DRAWINGS

The foregoing summary, as well as the following detailed description of presently preferred embodiments of the invention, will be better understood when read in conjunction with the appended drawings. For purposes of illustrating the present invention, embodiments are shown in the drawings which are presently preferred. It should be understood, however, that the invention is not limited to the precise arrangements and instrumentalities shown.

In the drawings:

FIGS. 1-2B are various views of a first embodiment of the cleaning device of the present invention;

FIG. 3 shows an outer section of a teeth assembly of the cleaning device of the present invention, including a teeth member;

FIG. 4 shows a lower section of a housing assembly of the present invention;

FIGS. 5 and 6 are exploded views of the cleaning device of the first embodiment;

FIG. 7 is a partial sectional view of the cleaning device of the first embodiment;

FIGS. 8A and 8B are top views of internal components of the cleaning device of the first embodiment in a rested state;

FIGS. 9A and 9B are top views of internal components of the cleaning device of the first embodiment in a retracted or engaged state;

FIGS. 10-12 are various views of a second embodiment of the cleaning device of the present invention;

FIG. 13 is an exploded view of the second embodiment of the cleaning device;

FIG. 14 shows the cleaning device of the second embodiment attached to a vacuum cleaner device;

FIGS. 15 and 16 show the components of the vacuum cleaner device of FIG. 14 in rested and retracted or engaged states, respectively; and

FIGS. 17 and 18 show an alternative embodiment of the cleaning device of the present invention illustrating an alternative housing assembly and teeth assembly.

To facilitate an understanding of the invention, identical reference numerals have been used, when appropriate, to designate the same or similar elements that are common to the figures. Further, unless stated otherwise, the features shown in the figures are not drawn to scale and are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

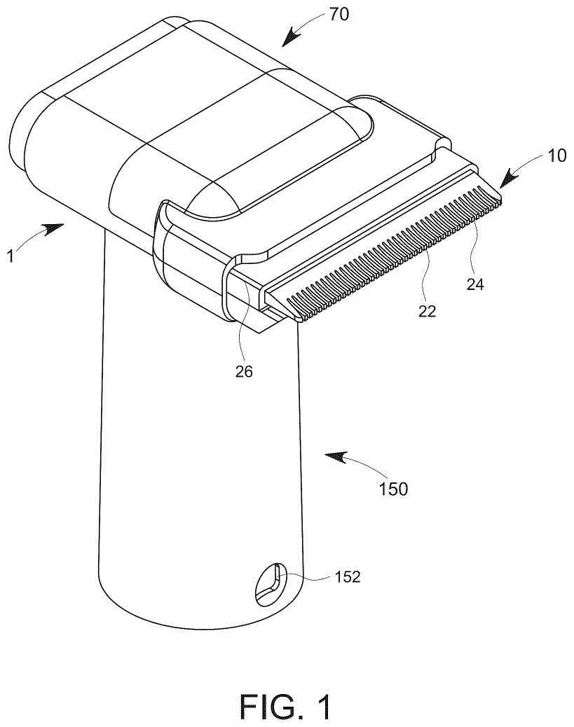

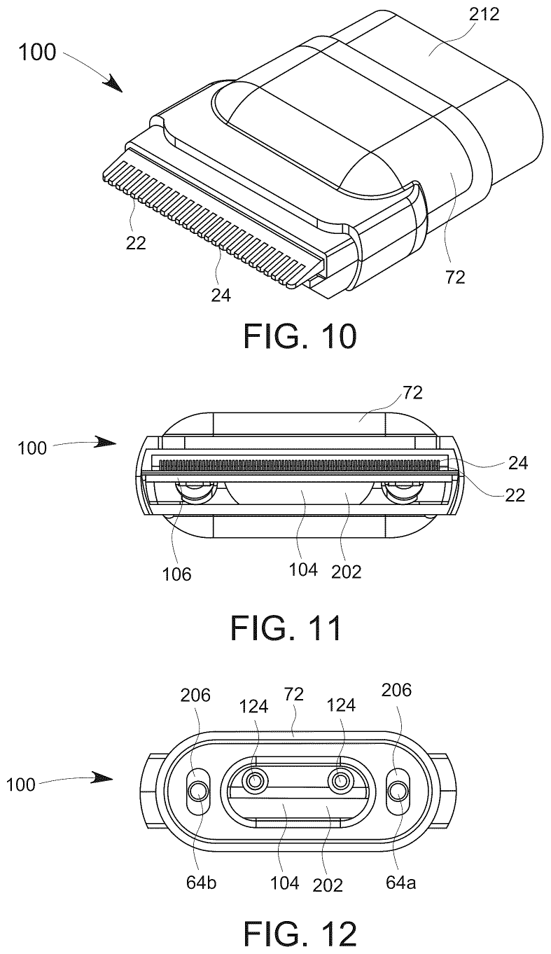

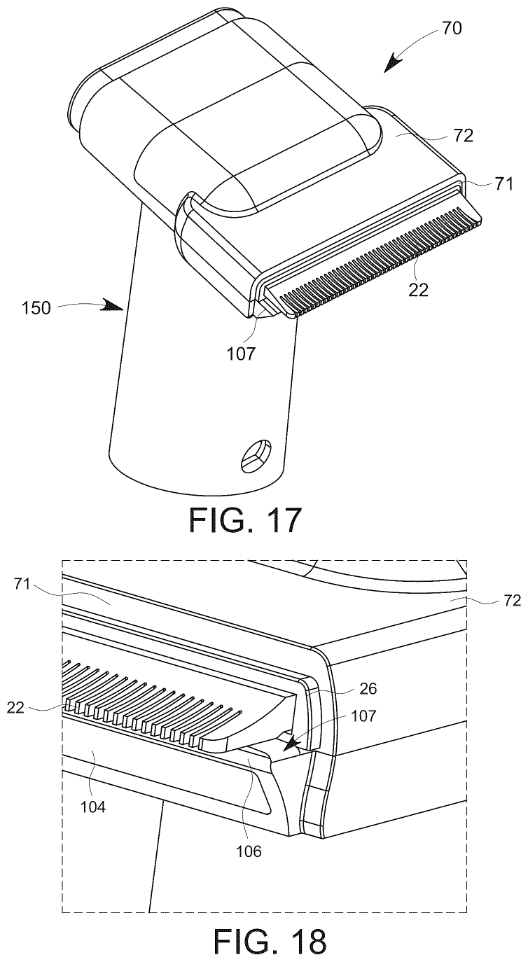

Referring to the figures, various embodiments of a cleaning device of the present invention and components thereof are shown. A first embodiment of the cleaning device 1 is shown in FIGS. 1-9B, and a second embodiment of the cleaning device 100 is shown in FIGS. 10-16. In general, the cleaning device 1, 100 includes a teeth assembly housed within a housing assembly. The housing assembly is coupled to a handle assembly. FIGS. 17 and 18 show an alternative embodiment with slight modifications to the housing assembly and the teeth assembly, as will be described in more detail below. The term “cleaning device” as used herein generally refers to any combination of the teeth assembly, housing assembly and handle assembly.

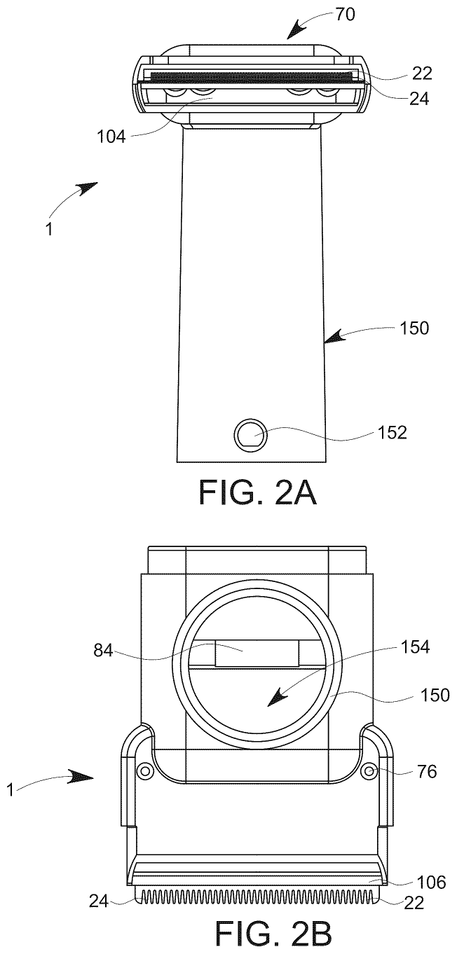

Referring to FIGS. 1-9B, the first embodiment of the cleaning device 1 of the present invention is shown. The cleaning device 1 includes a teeth assembly 10, housing assembly 70 and handle assembly 150. In this embodiment, the housing assembly 70 and the handle assembly 150 are constructed of plastic and integrally formed together via injection molding. In this embodiment, as shown in FIG. 2B, the handle assembly 150 is substantially hollow inside and configured to attach to a vacuum cleaner hose so that debris could travel through the hollow interior of the handle assembly 150 to the vacuum cleaner. As such, an aperture 152 is provided on the handle assembly 150 as an attachment means to the vacuum cleaner hose.

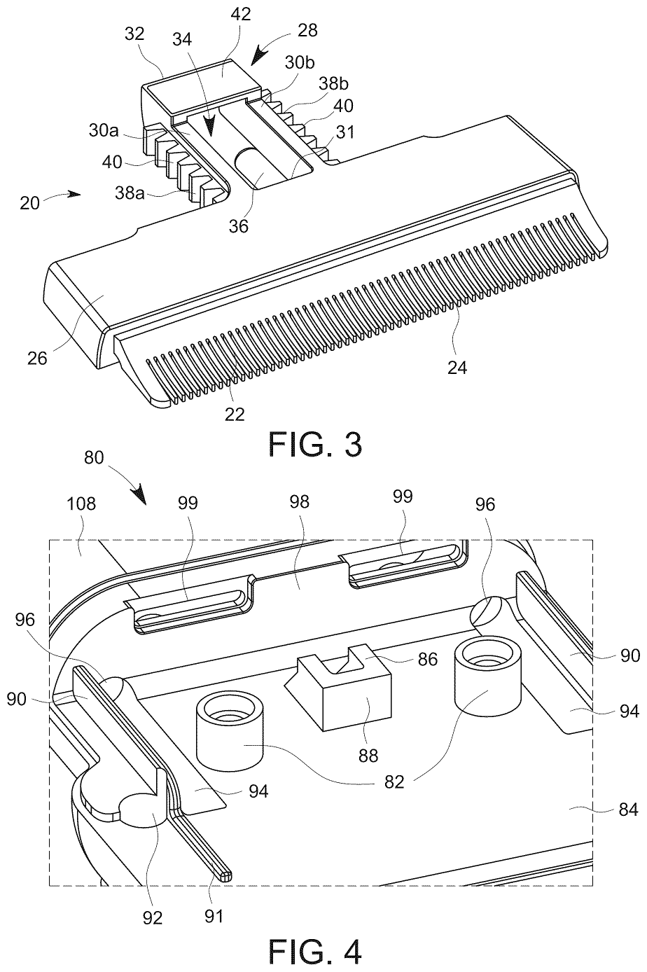

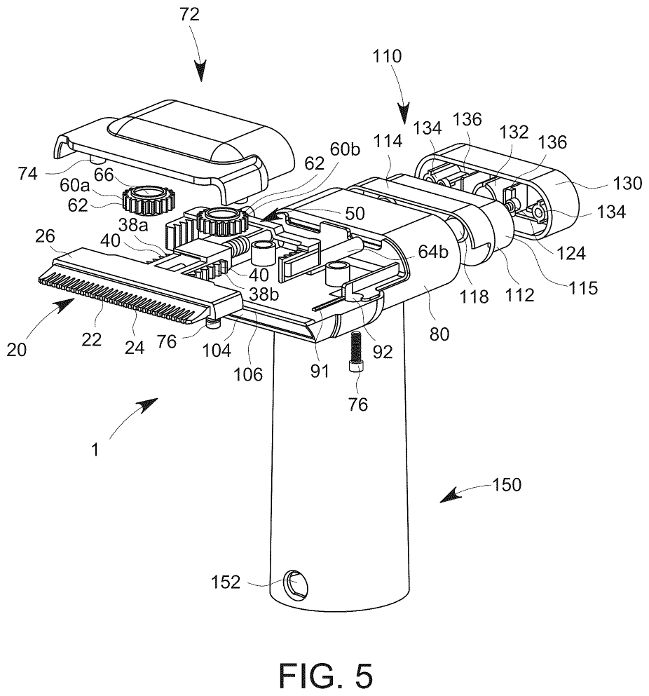

Referring to FIGS. 3 and 5-9B, the teeth assembly 10 includes an outer section 20 and an inner section 50. As shown in FIG. 3, the outer section 20 includes a teeth member 22 having a plurality of spaced apart teeth 24. The teeth member 22 is constructed of stainless steel but could be constructed of other metals such as aluminum or even hard, durable plastics. The teeth member 22 is coupled to a support member 26, preferably at least by adhesive, along the length of the teeth member 22 at an outer end of the support member 26. More specifically, as shown in FIG. 3, the outer end of the support member 26 is provided with a recess for the teeth member 22 to be inserted and fixed therein. An inner end of the support member 26 includes a retaining member 28 extending therefrom. The retaining member 28 includes opposing outer side walls 30a, 30b, an opposing outer front wall 31 and rear end 32 to form a retaining space 34. The inner end of the support member 26 also includes a retaining shaft 36 extending from the front wall 31 and is positioned within the retaining space 34. A biasing member 44 circumscribes the retaining shaft 36 as shown in FIGS. 5-9B. As shown, the length of the biasing member 44 is greater than the length of the retaining shaft 36. The retaining member 28 also includes an integrally formed upper member 42 extending between the outer side walls 30a, 30b and extending longitudinally from the rear end 32, as shown for example in FIG. 3. The upper member 42 serves to provide strength and stability to the retaining member 28 and also prevents the biasing member 44 from being displaced upwardly. As shown, the rear end 32 does not fully extend downwardly and the retaining space 34 is not fully enclosed at the inner end of the outer side walls 30a, 30b. As a result, an opening is formed below the upper member 42 and between the outer side walls 30a, 30b. Moreover, as shown in FIG. 3, the upper member 42 is elevated from the side walls 30a, 30b. The outer surface of each of the outer side walls 30a, 30b includes a rack 38a, 38b having aligned and spaced apart gear teeth 40. In this embodiment, the support member 26, retaining member 28 and shaft 36 are constructed of plastic and integrally formed by injection molding.

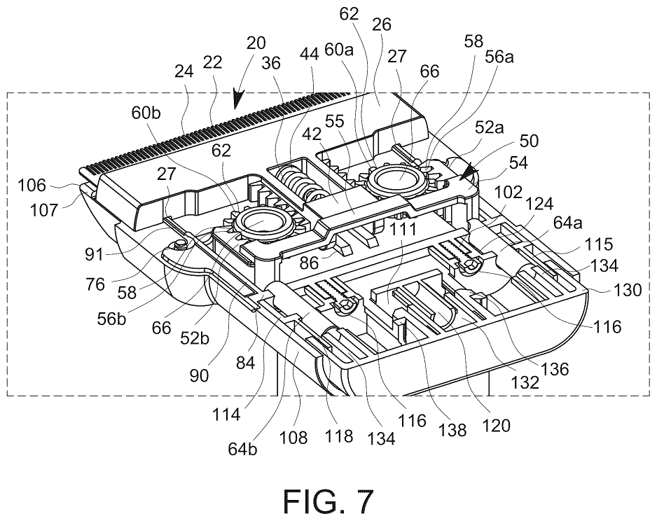

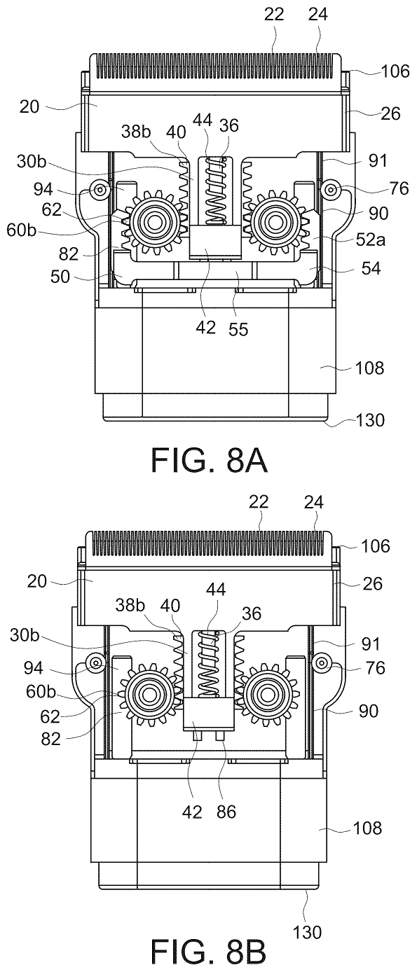

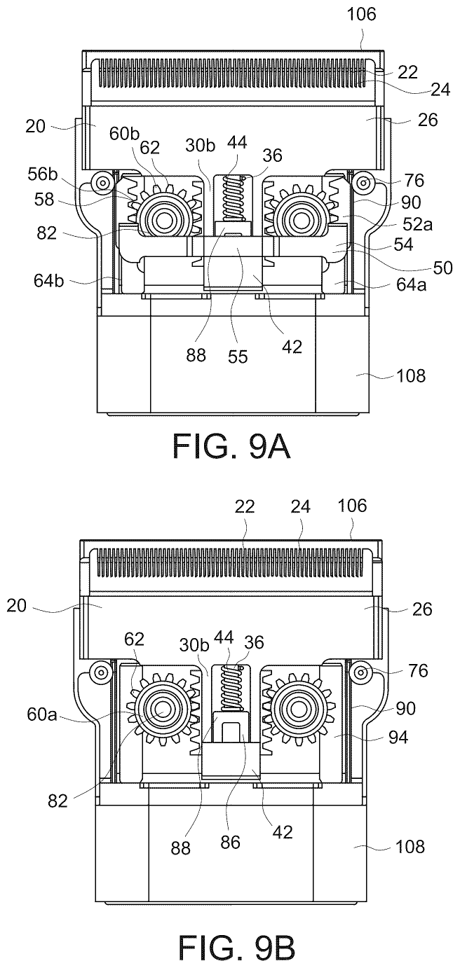

Referring to FIGS. 5-9B, the inner section 50 of the teeth assembly 10 includes a pair of inner side walls 52a, 52b coupled with a coupling member 54. For purposes of clarity, the teeth assembly 10 is shown with both the outer section 20 and inner section 50 in FIGS. 8A and 9A, while FIGS. 8B and 9B shows only the outer section 20. As shown in FIG. 7, the coupling member 54 is elevated and includes a further elevated central portion 55. The central portion 55 is positioned above the upper member 42 such that the upper member 42 is movable below the central portion 55, as shown in FIGS. 8A and 9A. In this manner, the inner section 50 is movable without interference of the components of the outer section 20 below. The inner section 50 also includes a pair of solid cylindrical engagement shafts 64a, 64b integrally formed and extending rearwardly from the inner side walls 52a, 52b. However, the engagement shafts 64a, 64b could be hollow inside and also could be separately formed with the inner section 50, i.e., attached thereto instead of being integrally formed. The engagement shafts 64a, 64b are slightly offset, that is, positioned inward relative to the inner side walls 52a, 52b. Each inner side wall 52a, 52b includes a rack 56a, 56b having gear teeth 58 positioned on inner surfaces thereof. The gear teeth 58 of the inner side wall racks 56a, 56b are sized and shaped substantially the same as the gear teeth 40 of the outer side wall racks 38a, 38b. As shown in FIGS. 5-7, a pair of pinions 60a, 60b are provided, each having an aperture 66 extending therethrough at a central axis. The pinions 60a, 60b also have gear teeth 62 matching the gear teeth 40, 58 of the racks 56a, 56b, 38a, 38b and are positioned between the respective racks 56a, 56b, 38a, 38b. As such, the outer section 20 is movable with respect to the inner section 50 via the rack and pinion arrangement, as shown in FIGS. 8A-9B and described in more detail below. In this embodiment, the inner side walls 52a, 52b, coupling member 54 and engagement shafts 64a, 64b are constructed of plastic and integrally formed by injection molding, but could be constructed of other materials as well.

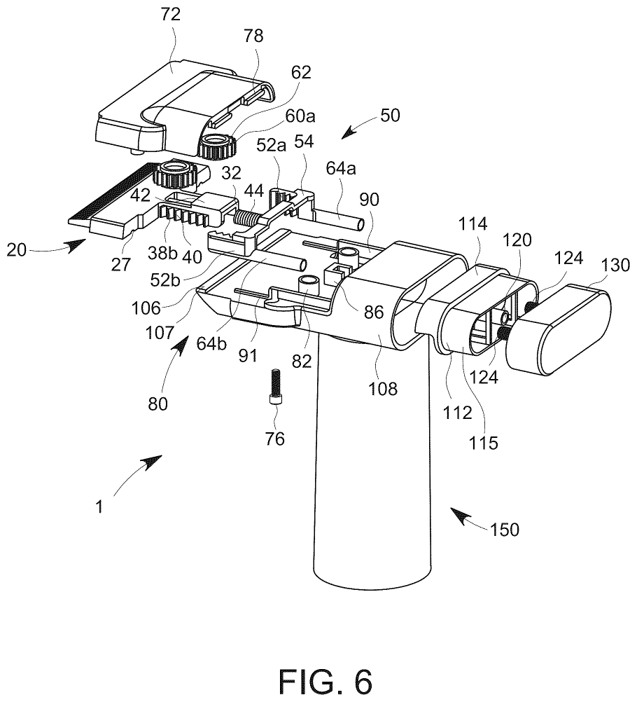

Referring to FIGS. 4-6, the housing assembly 70 includes an upper section 72, a lower section 80 and a rear section 110. The upper section 72 is configured to enclose the inner components of the teeth assembly 10 (outer section 20 and inner section 50) from above. The upper section 72 includes a pair of extension members 74 for receiving fasteners 76. In this embodiment, the extension members 74 are cylindrical and internally threaded and the fasteners 76 include matching threads. The upper section 72 also includes a pair of engagement members or hook members 78. In this embodiment, the engagement members or hook members 78 extend downward and outward, and include upwardly extending hooks (FIG. 6). In this embodiment, the upper section 72 is constructed of plastic and integrally formed by injection molding.

Still referring to FIGS. 4-6, the lower section 80 of the housing assembly 70 includes a pair of lower extension members 82 extending upwardly from a base member 84. As best shown in FIG. 4, the outer diameter of the lower extension members 82 are substantially similar in diameter as the apertures 66 of the pinions 60a, 60b such that the pinions 60a, 60b are free to rotate about the lower extension members 82 while being secured thereto. In this embodiment, the lower extension members 82 are cylindrical and hollow to minimize material cost but they could be completely solid as well. The base member 84 also includes a retaining member having opposing longitudinal retaining walls 86 coupled with a transverse retaining wall 88. The height of the retaining walls 86, 88 is less than the height of the upper member 42 so that the upper member 42 is movable above the retaining walls 86, 88, as shown in FIGS. 8A-9B. As well, the longitudinal retaining walls 86 are positioned between the outer side walls 30a, 30b such that the outer side walls 30a, 30b are movable without interference with the longitudinal retaining walls 86. The longitudinal retaining walls 86 ramp downward away from the transverse retaining wall 88, as shown in FIG. 4. With this configuration, the biasing member 44 is engaged with and positioned between the front wall 31 of the teeth member outer section 20 (FIG. 3) and the transverse retaining wall 88 of the housing assembly lower section 80 (FIG. 4), as shown, for example, in FIGS. 9A and 9B.

As shown in FIG. 4, the base member 84 also includes a pair of guide walls 90 extending upwardly therefrom and extending longitudinally. The guide walls 90 facilitate linear movement of the inner side walls 52a, 52b. Channels 94 are formed below the surface of the base member 84 and are positioned adjacent the guide walls 90 to further facilitate linear movement of the engagement shafts 64a, 64b. The channels 94 extend longitudinally through channel apertures 96 through a rear wall 98 of the base member 84. That is, the engagement shafts 64a, 64b are movable within the channels 94 and through the channel apertures 96. The base member 84 also includes a pair of guide rails 91 which extend in a longitudinal direction from the guide walls 90. The guide rails 91 are positioned within apertures or channels 27 formed at a bottom surface of the support member 26 to facilitate linear movement of the teeth assembly outer section 20. The function of the guide walls 90 and guide rails 91 can be better seen in FIG. 7.

In another embodiment, as shown in FIGS. 17 and 18, transverse ends 107 of the edge 106 of the base member 84 are chamfered, specifically, the upper surface of the outer edge 106 slopes downward away from the teeth member 22 transversely. The chamfered edge 107 helps prevent hair and debris from lodging between the teeth member 22 and the outer edge 106, making cleaning and combing smoother, and allowing debris and hair from the teeth member 22 to freely travel through an air passage 104 below the outer edge 106 and to the attached vacuum cleaner.

Referring to FIGS. 4-7, the rear wall 98 includes a pair of slots 99 for receiving the hooks of the engagement members 78 of the housing assembly upper section 72 (FIG. 4). A hollow shell 108 extends rearwardly from the rear wall 98, as shown in FIGS. 4-7. An opposing side of the rear wall 98 includes a pair of extension members 102 for receiving fasteners 124, as shown in FIG. 7. In this embodiment, the extension members 102 and fasteners 124 are configured for threaded engagement. A pair of vertical apertures 92 are positioned proximate outer ends of the guide walls 90 for receiving the fasteners 76 therethrough to the upper extension members 74 of the upper section 72 (FIGS. 5 and 6). An air passage 104 is formed below an outer edge 106 of the base member 84, as shown in FIG. 5. The air passage 104 connects to the hollow portion 154 of the handle assembly, shown in FIG. 2B. In this embodiment, the lower section 80 is integrally formed by injection molding plastic. In an alternative embodiment, the cleaning device could be constructed without the air passage 104 and hollow portion 154, and instead be solid at those portions. As a result, the cleaning device would be manual and used independently, rather than as a vacuum cleaner attachment.

In another embodiment, as shown in FIGS. 17 and 18, the front end 71 of the housing assembly upper section 72 is mounted flush with the front end of the teeth assembly support member 26. This prevents hair and debris from lodging between the housing assembly upper section 72 and the teeth assembly support member 26, especially when the teeth member 22 is retracted. As such, less maintenance is necessary.

Referring to FIGS. 5-7, the rear section 110 of the housing assembly 70 includes an intermediate component 112 having an upper flange 114 and lower flange 115, with the upper flange 114 having a larger cross-sectional dimension than the lower flange 115. The rear section 110 is also provided with a pair of apertures 116 for receiving the fasteners 124. Moreover, a pair of through holes 118, which extend from the channel apertures 96, are provided for receiving the engagement shafts 64a, 64b. Also, a male adapter 120 extends from a rear wall 111 of the rear section 110. In this embodiment, the male adapter 120 is substantially cylindrical and hollow, but it could take on other forms such as being completely solid. The upper flange 114 of the intermediate component 112 is shaped and sized to be positioned within the shell 108 of the lower section 80, as shown, for example, in FIG. 7.

Still referring to FIGS. 5-7, the rear section 110 also includes a pushbutton component 130. The pushbutton component 130 is substantially hollow and is configured to fit between the lower flange 115 of the intermediate component 112 and the shell 108 of the lower section 80 (FIG. 7). The pushbutton component 130 includes a female adapter 132 for receiving the male adapter 120. In this embodiment, the female adapter 132 is substantially cylindrical but it could take on other forms such as being completely solid. As shown in FIG. 7, the inner diameter of the female adapter 132 is shaped similar to the male adapter 120 but sized such that the male adapter 120 is slidable within the female adapter 132. Also, the female adapter 132 is provided with sufficient clearance for the male adapter 120 to be moveable longitudinally therewithin. The pushbutton component 130 also includes a pair of engagement members 134 on each side, which engage the ends of the engagement shafts 64a, 64b (FIG. 7). The pushbutton component 130 also includes a pair of catches 136 which engage posts 138 of the intermediate component 112 to keep the pushbutton component 130 positioned within the shell 108. As such, the pushbutton component 130 is configured to move in a longitudinal direction a maximum distance between the catches 136 and the rear wall 111. This distance is substantially the same as the distance between the front end of the inner side wall 52a, 52b and the front end of the channel 94 when the device is in a rested state.

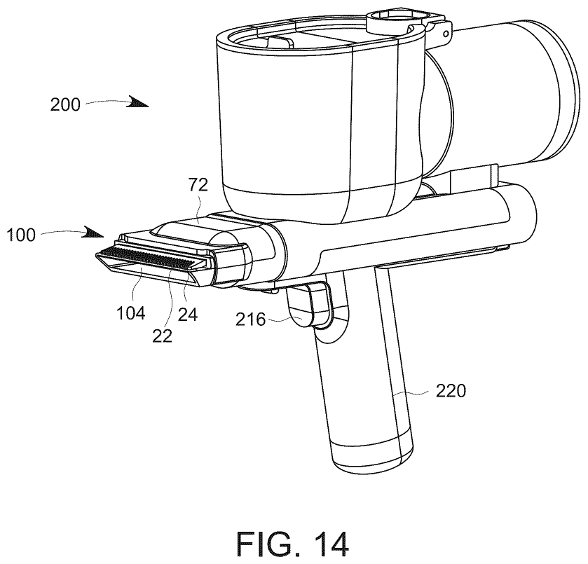

Referring to FIGS. 10-16, another embodiment of the cleaning device 100 of the present invention is shown. In this embodiment, the cleaning device 100 is configured to attach to a handheld vacuum cleaner 200 having a handle assembly, as shown in FIGS. 14-16. The cleaning device 100 has the same components and structure as the cleaning device 1 shown in FIGS. 1-9B, with a few exceptions. The same components, however, are labeled with the same reference numerals, and description relating to those components are incorporated by reference.

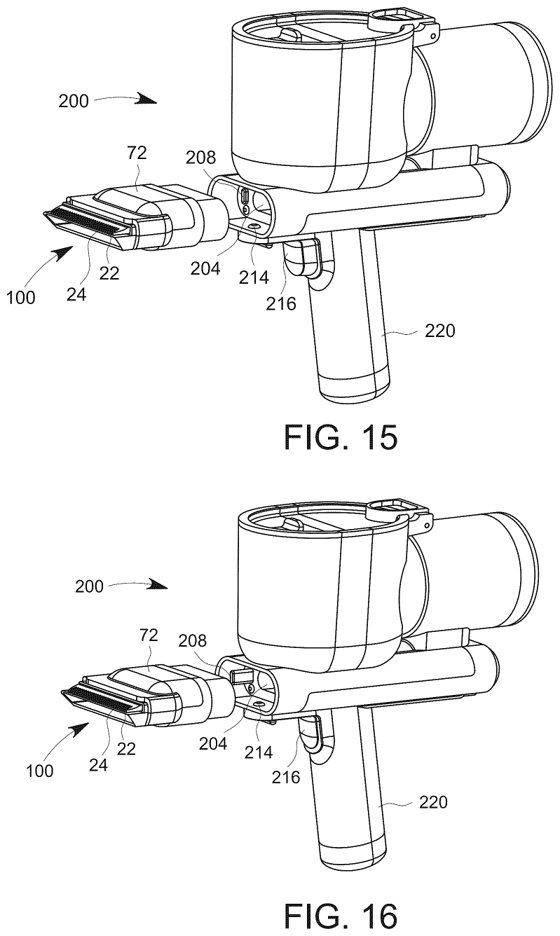

Referring to FIGS. 10-16, the cleaning device 100 includes an intermediate component 212 having an aperture 202 extending therethrough in fluid communication with the air passage 104 on one side and a vacuum cleaner inlet 204 on an opposing side. As such, debris collected by the cleaning device 100 travels through the air passage 104, aperture 202 and inlet 204 into the vacuum cleaner 200 and is collected therein. The intermediate component 212 also includes a pair of outer apertures 206 extending therethrough for receiving the engagement shafts 64a, 64b from one end and engagement members 208 from another end. Within the outer apertures 206, each shaft 64a, 64b engages respective engagement members 208. The intermediate component 212 is also provided with a lower aperture 210 for releasably locking with a locking component 214 of the vacuum cleaner 200, as shown in FIGS. 15 and 16. As shown in the figures, the vacuum cleaner 200 includes a trigger 216 on the handle assembly 220 which is operably coupled to the engagement members 208 such that the engagement members 208 are retracted when the trigger 216 is disengaged (FIGS. 8A, 8B and 15) and the engagement members 208 are extended when the trigger 216 is engaged (FIG. 16), thus moving the engagement shafts 64a, 64b forward (FIGS. 9A, 9B).

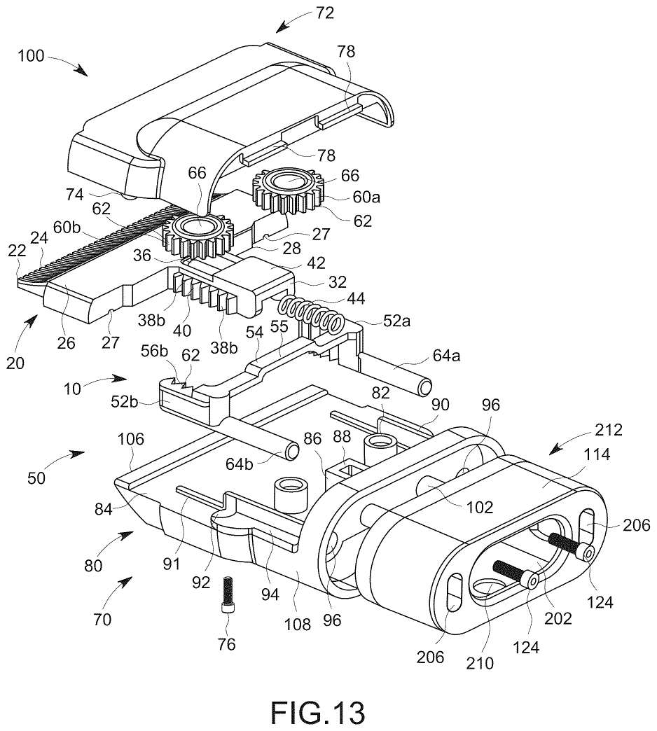

Referring to FIGS. 8A-9B, in operation, when the cleaning device 1, 100 is in the rested state, the biasing member 44 biases the teeth member 22 away from the transverse retaining wall 88 such that the teeth 24 of the teeth member 22 extends beyond the edge 106. A user engages the extended teeth 24 to a cleaning surface, including fur of a pet, by stroking or applying the teeth 24 therethrough. Debris and fur are collected between the teeth 24. With the vacuum cleaner running, the pushbutton 130 or trigger 216 is depressed, causing the engagement shafts 64a, 64b to move toward the teeth member 22, as shown in FIGS. 9A and 9B. As a result, the pinions 60a, 60b are rotated inwardly, causing the teeth assembly outer section 20, including the retaining shaft 36, to move rearwardly toward the transverse retaining wall 88, which causes the biasing member 44 to compress (FIGS. 9A and 9B). This also causes the collected debris and fur to be removed from the teeth 24 by the edge 106 and enter the air passage 104. Thus, the debris and/or fur are transferred to the vacuum cleaner via the hollow portion 154 (FIG. 2B), or the aperture and inlet 202, 204 (FIGS. 13 and 16). The pushbutton 130 or trigger 216 is disengaged or released, and the teeth member 22 returns to a ready to use or rested state, as shown in FIGS. 8A and 8B. In the alternative embodiment where the cleaning device is manually operated rather than with a vacuum cleaner, the debris or fur collected within the teeth 24 are simply released, for example, into a wastebasket, when the pushbutton 130 or trigger 216 is depressed.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

1. A cleaning device comprising a housing assembly and a teeth assembly,
the housing assembly comprising an upper section and a lower section, the housing assembly configured to receive the teeth assembly between the upper and lower sections, the lower section of the housing assembly comprising an outer edge;
the teeth assembly comprising an outer section and an inner section, the outer section and inner section movable in opposite directions of each other longitudinally, the outer section comprising a teeth member extending from the housing assembly and abutting the housing assembly outer edge,
wherein the teeth assembly outer section comprises an inner rack and the teeth assembly inner section comprises an outer rack, the inner and outer racks coupled to a rotatable pinion such that the teeth assembly inner and outer sections are movable relative to each other,
wherein the teeth assembly inner section further comprises an engagement shaft extending therefrom, such that when a force is applied to the engagement shaft, the teeth member is retracted;
wherein in a rested state, the teeth member of the teeth assembly is biased away from the housing assembly and extends substantially beyond the outer edge of the housing assembly lower section, and in an engaged state, the teeth member of the teeth assembly is retracted and is positioned substantially inward of the outer edge of the housing assembly lower section.

2. The cleaning device of claim 1, wherein the teeth assembly outer section further comprises a retaining shaft extending away from the teeth member, the retaining shaft circumscribed with a biasing member, the biasing member being extended when the cleaning device is in the rested state and the biasing member being compressed when the cleaning device is in an engaged state.

3. The cleaning device of claim 1, further comprising an engagement member, the engagement member operably coupled to the engagement shaft such that the engagement shaft is movable longitudinally when a force is applied to the engagement member.

4. The cleaning device of claim 1, further comprising an air passage positioned proximate the teeth member, the air passage configured to receive debris collected in the teeth member.

5. A cleaning device comprising a housing assembly and a teeth assembly,
the housing assembly comprising an upper section and a lower section, the housing assembly configured to receive the teeth assembly, the lower section of the housing assembly comprising an outer edge;
the teeth assembly comprising an outer section and an inner section, the outer section and inner section movable in opposite directions of each other longitudinally, the outer section comprising a teeth member extending from the housing assembly and abutting the housing assembly outer edge, wherein the teeth assembly outer section comprises an inner rack and the teeth assembly inner section comprises an outer rack, the inner and outer racks coupled to a rotatable pinion such that the teeth assembly inner and outer sections are movable relative to each other;
wherein in a rested state, the teeth member of the teeth assembly is biased away from the housing assembly and extends substantially beyond the outer edge of the housing assembly lower section, and in an engaged state, the teeth member of the teeth assembly is retracted and is positioned substantially inward of the outer edge of the housing assembly lower section.

6. The cleaning device of claim 5, wherein the teeth assembly inner section further comprises an engagement shaft extending therefrom, such that when a force is applied to the engagement shaft, the teeth member is retracted.

7. The cleaning device of claim 6, wherein the housing assembly lower section further comprises a channel for receiving the engagement shaft.

8. The cleaning device of claim 6, wherein the housing assembly lower section further comprises an aperture extending therethrough longitudinally, the engagement shaft extending therethrough.

9. The cleaning device of claim 6, further comprising an engagement member, the engagement member operably coupled to the engagement shaft such that the engagement shaft is movable longitudinally when a force is applied to the engagement member.

10. The cleaning device of claim 5, wherein the teeth assembly outer section further comprises a retaining shaft extending away from the teeth member, the retaining shaft circumscribed with a biasing member, the biasing member being extended when the cleaning device is in the rested state and the biasing member being compressed when the cleaning device is in an engaged state.

11. The cleaning device of claim 5, further comprising an air passage positioned proximate the teeth member, the air passage configured to receive debris collected in the teeth member.

12. A cleaning device comprising a housing assembly and a teeth assembly,
the housing assembly comprising an upper section and a lower section, the housing assembly configured to receive the teeth assembly, the lower section of the housing assembly comprising an outer edge;
the teeth assembly comprising an outer section and an inner section, the outer section and inner section movable in opposite directions of each other longitudinally, the outer section comprising a teeth member extending from the housing assembly and abutting the housing assembly outer edge;
wherein in a rested state, the teeth member of the teeth assembly is biased away from the housing assembly and extends substantially beyond the outer edge of the housing assembly lower section, and in an engaged state, the teeth member of the teeth assembly is retracted and is positioned substantially inward of the outer edge of the housing assembly lower section.

13. The cleaning device of claim 12, wherein the teeth assembly outer section comprises an inner rack and the teeth assembly inner section comprises an outer rack, the inner and outer racks coupled to a rotatable pinion such that the teeth assembly inner and outer sections are movable relative to each other.

14. The cleaning device of claim 13, wherein the teeth assembly inner section further comprises an engagement shaft extending therefrom, such that when a force is applied to the engagement shaft, the teeth member is retracted.

15. The cleaning device of claim 14, wherein the housing assembly lower section further comprises a channel for receiving the engagement shaft.

16. The cleaning device of claim 15, wherein the teeth assembly outer section further comprises a retaining shaft extending away from the teeth member, the retaining shaft circumscribed with a biasing member, the biasing member being extended when the cleaning device is in the rested state and the biasing member being compressed when the cleaning device is in an engaged state.

17. The cleaning device of claim 16, wherein the housing assembly lower section further comprises a transverse retaining wall, the biasing member engaging the transverse retaining wall.

18. The cleaning device of claim 17, wherein the housing assembly lower section further comprises an aperture extending therethrough longitudinally, the engagement shaft extending therethrough.

19. The cleaning device of claim 18, further comprising an engagement member, the engagement member operably coupled to the engagement shaft such that the engagement shaft is movable longitudinally when a force is applied to the engagement member.

20. The cleaning device of claim 19, further comprising an air passage positioned proximate the teeth member, the air passage configured to receive debris collected in the teeth member.
